(19) United States
(12) Patent Application Publication
(10) Pub. No.: US 2007/0135220 A1
(43) Pub. Date: Jun. 14, 2007

(54) Wheel hub/universal joint assembly

(75) Inventor: Hans-Heinrich Welschof, Rodenbach (DE)

Correspondence Address: ARTZ & ARTZ, P.C., 28333 TELEGRAPH RD., SUITE 250, SOUTHFIELD, MI, 48034, US

(73) Assignee: GKN DRIVELINE DEUTSCHLAND GMBH, Offenbach (DE)

(21) Appl. No.: 10/568,898

(22) PCT Filed: Jun. 5, 2004
(86) PCT No.: PCT/EP04/06089

§ 371 Date: Jul. 13, 2006

(30) Foreign Application Priority Data
Aug. 20, 2003 (DE) 103 38 172.4

(51) Int. Cl. F16D 3/00

(52) U.S. Cl. 464/140

(57) ABSTRACT

A wheel hub/universal joint assembly having a wheel hub (1) with a wheel flange (2) and a universal joint (3) for attaching a driveshaft (4). The universal joint (3) is connectable to the wheel hub (1) by a central bolt/nut connection. The wheel hub (1) has a central passage (16) with a first aperture (22) with a first diameter (D₁) at the flange end, and a second aperture (23) with a second diameter (D₂) at the joint end. The second diameter is greater than first diameter. The first aperture is passed through by a bolt (19) or a threaded pin (34) of the bolt/nut connection. In the second aperture there are provided inner teeth (17) which are engaged by a journal (14) of the universal joint (3) with corresponding outer teeth (15).

The invention relates to a wheel hub/universal joint assembly comprising a wheel hub with a wheel flange and a universal joint for attaching a driveshaft, which universal joint is connected to the wheel hub by means of a central bolt/nut connection.

Such wheel hub/universal joint assemblies are known from the state of the art. For example, DE 42 10 461 C2 shows an assembly, wherein the wheel hub and the universal joint are connected to one another by a central bolt/nut connection. The journal is provided in the form of a so-called long journal whose cross-section is approximately constant along its length and which fully penetrates the bore of the wheel hub. The journal comprises a central portion with outer teeth which, for torque transmitting purposes, engage corresponding inner teeth in the bore of the wheel hub. At the end facing the wheel, a nut has been threaded on to the journal, which nut is axially supported against a shoulder surrounding the bore. Such an assembly comprising a long journal and a nut is characterised by a relatively high degree of elasticity which can result in settlement symptoms and a decreasing clamping force at the wheel bearing.

DE 34 30 067 C2 proposes a wheel hub/universal joint assembly for being attached to a driveshaft wherein the journal of the universal joint is provided in the form of a short journal which extends along only part of the bore length of the wheel hub. The bore whose diameter is approximately constant along its length, at its end facing the joint, comprises inner teeth which, for torque transmitting purposes, are engaged by corresponding outer teeth of the journal. On the radial outside, the wheel hub forms the inner bearing race of a wheel bearing which, by means of an associated outer bearing race, is attached to a wheel carrier. The dimensions of the wheel bearing are dependent on the diameter of the journal of the universal joint and on the bore diameter of the wheel hub. For axially fixing the wheel hub to the journal, there is provided a pin which is threaded centrally into the journal and is axially supported against an annular disc arranged in the bore or at the wheel-facing end of the bore.

It is therefore the object of the present invention to propose a wheel hub/universal joint assembly which permits a reduction in the diameter of the wheel bearing as compared to prior art solutions while ensuring adequate clamping conditions between the wheel hub and universal joint, respectively which permits an increase in strength, with the size of the assembly remaining unchanged.

In accordance with the invention, the objective is achieved by a wheel hub/universal joint assembly which comprises a wheel hub with a wheel flange and a universal joint for attaching a driveshaft, which universal joint is connected to the wheel hub by means of a central bolt/nut connection, wherein the wheel hub comprises a central passage with an aperture with a first diameter D₁ at the flange end and an aperture with a second diameter D₂ at the joint end, which second diameter D₂is greater than first diameter D₁, the aperture at the flange end is passed through by a bolt or a threaded pin of the bolt/nut connection and in the aperture at the joint end there are provided inner teeth which are engaged by a journal of the universal joint with corresponding outer teeth.

By using a short journal in connection with a passage with a variable cross-section, said solution is advantageous in that the load bearing cross-section of the wheel hub at the flange end is increased, so that the stresses in the wheel hub as a whole are reduced. Therefore, the wheel hub/universal joint assembly can be radially smaller without losing any strength as compared to conventional solutions. The reduction in the diameter of the wheel hub/universal joint assembly results in a reduction in weight and thus also in cost savings. Furthermore, the aperture at the flange end with a smaller diameter results in a shoulder which supports the head of a bolt or a nut without having to use a supporting disc.

According to a preferred embodiment of the invention it is proposed that the length of the journal is shorter than the length of the passage. The passage preferably comprises a flange-facing portion which includes the flange-facing aperture and whose diameter D₁ remains constant along its length, a joint-facing portion which includes the joint-facing aperture and whose diameter D₂ remains constant along its length, as well as a connecting portion whose diameter is variable along its length and which is arranged between the flange-facing portion and the joint-facing portion. In a preferred embodiment, the joint-facing portion is only slightly longer than the depth of immersion of the journal in the mounted condition, i.e. the connecting portion is arranged axially in the region of a flange-facing inner bearing race of a double-row wheel bearing. As a result, there is achieved a high strength value of the wheel hub, more particularly in the high-stress region. The connecting portion can be stepped or conical.

According to a preferred embodiment, it is proposed that the bolt/nut connection comprises a central threaded bore in the journal and a bolt which is threaded into same, which passes through the passage of the wheel hub and whose head, at the aperture of wheel hub at the flange end, is supported against a shoulder. The diameter of the aperture at the flange end preferably corresponds to the diameter of the bolt. This results in a particularly high degree of stability for the wheel hub. The bolt is preferably threaded into an outer joint part of the universal joint or into a journal connected thereto. However, for certain applications, the bolt can also be connected to the inner joint part, in which case the outer joint part would be attached to the driveshaft.

According to an alternative embodiment it is proposed that the bolt/nut connection comprises a central threaded pin which is attached to the journal and which passes through the passage of the wheel hub, as well as a nut which is threaded onto said central threaded pin and which is supported against a shoulder of the wheel hub. The diameter of the aperture at the flange end preferably corresponds approximately to the diameter of the threaded pin which comprises a smaller diameter than the journal. As a result, the entire connection comprises a high degree of elasticity, so that good clamping conditions of the wheel hub relative to the universal joint and thus also to the wheel bearing are always ensured.

According to a further embodiment, the journal is produced so as to be integral with the threaded pin and an outer joint part of the universal joint. For certain applications, the threaded pin can also be associated with the inner joint part. The universal joint, in addition to the outer joint part with outer ball tracks, comprises an inner joint with inner ball tracks, a torque transmitting ball per pair of opposed ball tracks, as well as a ball cage holding the balls in the angle-bisecting plane. The inner joint part is connectable in a rotationally fast way to a driveshaft via a toothing. The diameter of the toothing between the wheel hub and the journal approximately corresponds to the diameter of the toothing between the inner joint part and the driveshaft. Furthermore, according to a further embodiment, the load bearing length of the toothing between the wheel hub and the journal is smaller than the load bearing length of the toothing between the inner joint part and the driveshaft connectable to the latter.

According to a preferred embodiment, there is provided a double row wheel bearing having at least one separate inner bearing race which has been slipped on to the wheel hub and which, by means of an end face, axially projects from the end of the wheel hub, with the wheel bearing being axially pretensioned by a contact face of the outer joint part, which contact face acts on the end face of the inner bearing race. This embodiment ensures that the outer joint part, by means of its contact face, is supported against the inner bearing race and thus firmly clamped to the wheel hub. It is possible, via the contact face between the inner bearing race and the outer joint part, to introduce and support bending moments. It is thus possible for the outer toothing of the journal, while maintaining a comparable diameter, to be shorter than the toothing between the inner joint part and the driveshaft. As a result, the passage of the wheel hub can be tapered towards the aperture at the flange end, so that, in this region, the cross-section of the wheel hub is increased.

According to a further embodiment, the outer joint part comprising the journal is produced from a surface-hardenable, heat-treatable steel. The inner toothing of the wheel hub and/or the outer toothing of the journal are preferably produced in a non-chip-forming way by drawing or hammering. Because the journal is provided in the form of a short journal, the inner toothing of the wheel hub and the outer toothing of the journal are correspondingly shorter than in the case of conventional solutions, so that the toothing can be produced with a greater degree of accuracy. As a result, it is possible to observe small tolerances. The journal or the journal with the threaded pin are preferably induction-hardened. The heat-treatable steel can be provided in the form of 45B2M for example.

Below, the invention will be described in greater detail with reference to the drawing wherein

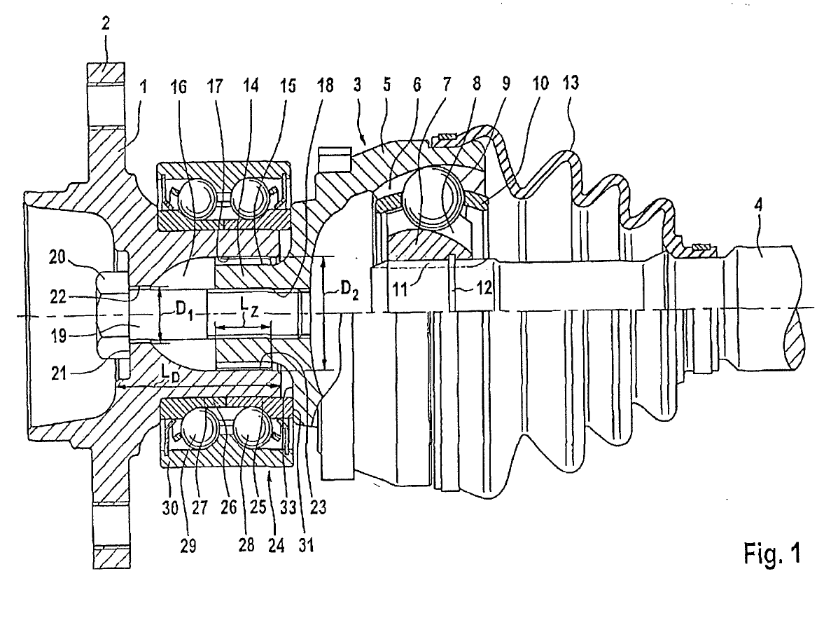

FIG. 1 shows an inventive wheel hub/universal joint assembly in a partial longitudinal section in a first embodiment and

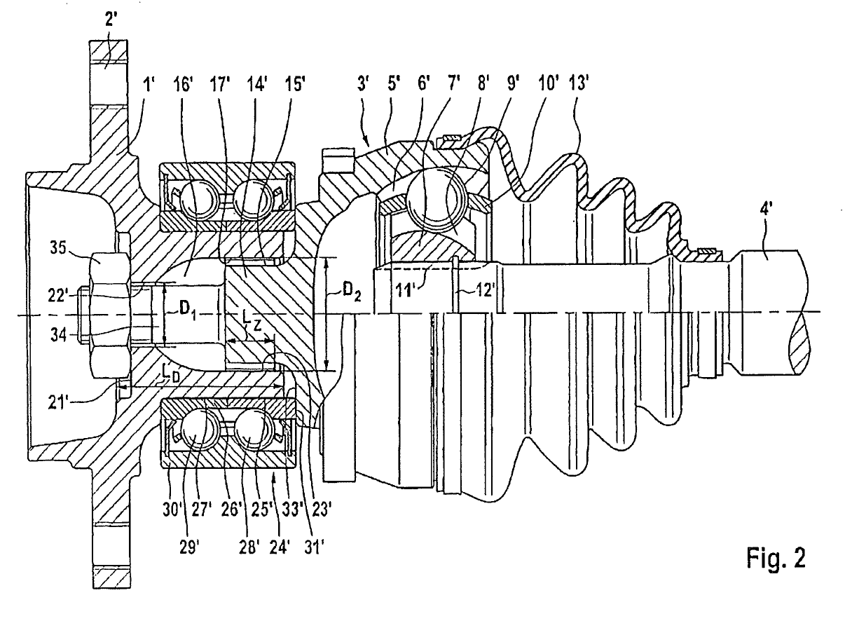

FIG. 2 shows an inventive wheel hub/universal joint assembly in a partial longitudinal section in a second embodiment.

FIG. 1 shows a wheel hub/universal joint assembly which comprises a wheel hub 1 with an integrally formed-on wheel flange 2 as well as a universal joint 3 tightened to the wheel hub 1. The universal joint 3 is connected to the driveshaft 4 in a rotationally fast way and serves to transmit torque from the driveshaft 4 to the wheel hub 1 under angular movements. The universal joint 3 comprises an outer joint part 5 with outer ball tracks 6, an inner joint part 7 with inner ball tracks 8, torque transmitting balls 9 accommodated in a pair of outer ball tracks 6 and inner ball tracks 8 arranged opposite one another, as well as a ball cage 10 holding the balls in the angle-bisecting plane. The inner joint part 7 comprises a bore. 11 with a longitudinal toothing into which the driveshaft 4 is inserted in a rotationally fast way and axially secured by a securing ring 12. The joint chamber is sealed towards the outside by a convoluted boot 13, thus preventing dirt from entering and lubricant from escaping from the joint chamber.

A central journal 14 with an outer toothing 15 is attached to the outer joint part 5 and, for torque transmitting purposes, engages a passage 16 with corresponding inner toothing 17 of the wheel hub 1. The wheel hub 1 and the universal joint 3 are tightened to one another by a bolt/hut connection which comprises a central threaded bore 18 in the journal 14 as well as a bolt 19 which is threaded into same and which axially penetrates the passage 16 and, by means of a bolt head 20, is supported against a shoulder 21 in a turned recess of the wheel hub. In the region following the turned recess, the passage 16 comprises a flange-facing portion with an aperture. 22 whose diameter D₁ approximately corresponds to the diameter of the bolt 19, as well as a joint-facing portion with an aperture 23 with a greater diameter D₂ into which the journal 14 has been inserted. The length L_{z} of the journal 14 is smaller than the length L_{D} of the passage 16. As a result, the passage 16 in a connecting portion can be tapered towards the wheel flange 2, as a result of which the cross-section of the wheel hub 1 is increased and there is achieved an increased fracture strength in the region of maximum stress. The tapered passage 16 with a smaller aperture 22 at the flange end simultaneously forms a shoulder, 21 against which the bolt head of the bolt 19 can be supported without having to provide a supporting disc.

By means of a wheel bearing 24, the wheel hub/universal joint assembly is rotatably supported in a wheel carrier (not illustrated) The wheel bearing 24 comprises two inner bearing races 25, 26 positioned on a bearing face 27 of the wheel hub 1, 1, as well as rolling contact members 28, 29 and a one-part outer bearing race 30. The inner bearing race 25 at the joint end, by means of its end face 31, axially projects from the end of the wheel hub 1 and is axially supported against a shoulder with a radial contact face 33 and pretensioned by the bolt/nut connection. Because the shoulder rests against the inner bearing race 25, there is provided support for the bending moments generated when the wheel hub/universal joint assembly is operated, so that the toothing between the wheel hub 1 and the journal 14 are largely free from bending moments. As a result, the load bearing teeth length between the outer toothing 15 of the journal 14 and the inner toothing 17 of the passage 15 can be kept shorter than the teeth length between the inner joint part 7 and the driveshaft 4. The shortness of the toothing between the wheel hub 1 and the journal 14, in turn, has a positive effect on the wheel hub cross-section which is reinforced towards the aperture 22 at the flange end. This is advantageous for the fracture strength of the wheel hub 1 because in the region of the inner bearing race 26 at the flange end where the stresses are greatest, the wheel hub cross-section is reinforced. Overall, it is possible, as a result of said design, to reduce the diameter of the wheel bearing, which leads to a reduction in weight and costs.

FIG. 2 shows an alternative embodiment of an inventive wheel hub/universal joint assembly with a threaded pin at the journal. This embodiment largely corresponds to the above embodiment with a bolt threaded into the journal, so that reference is made to the description of FIG. 1. Identical components have been given reference numbers with an apostrophe. In contrast to the embodiment according to FIG. 1, the present embodiment comprises an outer joint part 5′ with a journal 14′ to which there is attached a threaded pin 34 which passes through the passage 16′ and is clamped to the wheel hub 1′ by a threaded-on nut 35 supported against a shoulder 21′ of the wheel hub 1′. The diameter of the threaded pin 34 approximately corresponds to the diameter D₁′ of the flange-facing aperture 22′ of the passage 16′. The threaded pin 34 has a smaller diameter than the journal 14′. As a result, the diameter of the passage 16′ can be tapered towards the wheel flange 2′, so that the cross-section of the wheel hub 1′ is increased in this region. This results in the advantages referred to above. Furthermore, the entire connection comprises a high degree of elasticity, so that the wheel hub, the universal joint and the wheel bearing are securely clamped to one another. The threaded pin 34, the journal 14′ and the outer joint part 5′ are produced from surface-hardenable, heat-treatable steel so as to form one piece, with steel 45B2M being particularly suitable. For the purpose of increasing the hardness-of the journal 14′ with the threaded pin 34, said steel is induction hardened.

### Wheel Hub/Universal Joint Assembly

List of reference numbers

1. wheel hub
2. wheel flange
3. universal joint
4. driveshaft
5. outer joint part
6. outer ball track
7. inner joint part
8. inner ball track
9. ball
10. ball cage
11. bore
12. securing ring
13. convoluted boot
14. journal
15. outer teeth
16. passage
17. inner teeth
18. threaded bore
19. bolt
20. bolt head
21. shoulder
22. flange-facing aperture
23. joint-facing aperture
24. wheel bearing
25. inner bearing race
26. inner bearing race
27. bearing face
28. rolling contact member
29. rolling contact member
30. outer bearing race
31. end face
32. -
33. contact face
34. threaded pin
35. nut
D₁ diameter
D₂ diameter
L_{D} length of passage
D_{z} length of journal

What is claimed is:

1-16. (canceled)

17. A wheel hub/universal joint assembly comprising:
a wheel hub with a wheel flange and a universal joint for attaching a driveshaft, the universal joint being connected to the wheel hub by a central bolt/nut connection,
wherein the wheel hub comprises a central passage with a first aperture with a first diameter (D₁) at the wheel flange end, and a second aperture with a second diameter (D₂) at the joint end, wherein the second diameter (D₂) is greater than first diameter (D₁),
the first aperture is passed through by a bolt or a threaded pin of the bolt/nut connection, and
the second aperture comprises inner teeth which engage corresponding outer teeth of a journal of the universal joint.

18. A wheel hub/universal joint assembly according to claim 17, wherein the bolt/nut connection comprises a central threaded bore in the journal, and a bolt which is threaded into same, the bolt passing through the central passage and whose head, at the first aperture, is supported against a shoulder.

19. A wheel hub/universal joint assembly according to claim 17, wherein the first diameter (D₁) approximately corresponds to a diameter of the bolt or pin.

20. A wheel hub/universal joint assembly according to claim 18, wherein the bolt is threaded into an outer joint part of the universal joint.

21. A wheel hub/universal joint assembly according to claim 17, wherein the bolt/nut connection comprises a central threaded pin attached to the journal and which passes through the central passage, and a nut threaded onto said central threaded pin and supported against a shoulder of the wheel hub.

22. A wheel hub/universal joint assembly according to claim 21, wherein the first diameter (D₁) approximately corresponds to the diameter of the threaded pin.

23. A wheel hub/universal joint assembly according to claim 21, wherein the journal is integrally formed with the threaded pin and an outer joint part of the universal joint.

24. A wheel hub/universal joint assembly according to claim 17, wherein the inner teeth of the wheel hub or the outer teeth of the journal are produced in a non-chip-forming way by drawing or hammering.

25. A wheel hub/universal joint assembly according to claim 17, wherein a diameter of the teeth between the wheel hub and the journal approximately corresponds to a diameter of teeth between an inner joint part of the universal joint and the driveshaft connectable thereto.

26. A wheel hub/universal joint assembly according to claim 17, wherein a load bearing length of the teeth between the wheel hub and the journal is less than a load bearing length of teeth between an inner joint part of the universal joint and the driveshaft.

27. A wheel hub/universal joint assembly according to claim 25, wherein a load bearing length of the teeth between the wheel hub and the journal is less than a load bearing length of teeth between the inner joint part and the driveshaft.

28. A wheel hub/universal joint assembly according to claim 17, further comprising a double-row wheel bearing with at least one separate inner bearing race which is slipped onto the wheel hub and which, by an end face, axially projects from an end of the wheel hub, wherein the wheel bearing is axially pretensioned by a contact face of an outer joint part of the universal joint acting on the end face of the inner bearing race.

29. A wheel hub/universal joint assembly according to claim 25, further comprising a double-row wheel bearing with at least one separate inner bearing race which is slipped onto the wheel hub and which, by an end face, axially projects from an end of the wheel hub, wherein the wheel bearing is axially pretensioned by a contact face of an outer joint part of the universal joint acting on the end face of the inner bearing race.

30. A wheel hub/universal joint assembly according to claim 26, further comprising a double-row wheel bearing with at least one separate inner bearing race which is slipped onto the wheel hub and which, by an end face, axially projects from an end of the wheel hub, wherein the wheel bearing is axially pretensioned by a contact face of an outer joint part of the universal joint acting on the end face of the inner bearing race.

31. A wheel hub/universal joint assembly according to claim 17, wherein an outer joint part of the universal joint comprises the journal and is produced from a surface-hardenable, heat-treatable steel.

32. A wheel hub/universal joint assembly according to claim 17, wherein the journal or the pin are induction-hardened.

33. A wheel hub/universal joint assembly according to claim 17, wherein a length (L_{z}) of the journal is shorter than a length (L_{D}) of the central passage.

34. A wheel hub/universal joint assembly according to claim 17, wherein the central passage comprises a flange-facing portion including the first aperture and whose diameter (D₁) remains constant along its length, a joint-facing portion which includes the second aperture and whose diameter (D₂) remains constant along its length, a connecting portion whose diameter is variable along its length and which is arranged between the flange-facing portion and the joint-facing portion.

35. A wheel hub/universal joint assembly according to claim 34, wherein the connecting portion is arranged axially in a region of a flange-facing inner bearing race of a double-row wheel bearing.
